(19) United States
(12) Patent Application Publication
(10) Pub. No.: US 2010/0183228 A1
(43) Pub. Date: Jul. 22, 2010

(54) SPECIFYING POSITION OF CHARACTERISTIC PORTION OF FACE IMAGE

(75) Inventors: Kenji Matsuzaka, Shiojiri-shi (JP); Masaya Usui, Shiojiri-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/690,037

(22) Filed: Jan. 19, 2010

(30) Foreign Application Priority Data
Jan. 20, 2009 (JP) 2009-009767

(51) Int. Cl. G06K 9/46

(52) U.S. Cl. 382/195

(57) ABSTRACT

Image processing apparatus and methods are provided for specifying the positions of predetermined characteristic portions of a face image. A method includes determining an initial disposition of characteristic points in a target face image, applying a transformation to at least one of the target face image or the reference face image, and updating the disposition of the characteristic points in response to a comparison between at least one of the transformed target face image and the reference face image or the target face image and the transformed reference face image.

### CROSS-REFERENCES TO RELATED APPLICATIONS

Priority is claimed under 35 U.S.C. §119 to Japanese Application No. 2009-009767 filed on Jan. 20, 2009 which is hereby incorporated by reference in its entirety.

The present application is related to U.S. application Ser. No. ______, entitled “Image Processing Apparatus For Detecting Coordinate Positions of Characteristic Portions of Face,” filed on ______, (Attorney Docket No. 21654P-026800US); U.S. application Ser. No. ______, entitled “Image Processing Apparatus For Detecting Coordinate Position of Characteristic Portion of Face,” filed on ______, (Attorney Docket No. 21654 P-026900US); and U.S. application Ser. No. ______, entitled “Image Processing For Changing Predetermined Texture Characteristic Amount of Face Image,” filed on Ser. No. ______, (Attorney Docket No. 21654P-027000US); each of which is incorporated herein by reference.

### BACKGROUND

1. Technical Field

The present invention relates to technology for specifying the positions of predetermined characteristic portions of a face image.

2. Related Art

An active appearance model (also abbreviated as “AAM”) has been used as a technique for modeling a visual event. In the AAM technique, a face image is, for example, modeled by using a shape model that represents the face shape by using positions of characteristic portions of the face and a texture model that represents the “appearance” in an average face shape. The shape model and the texture model can be created, for example, by performing statistical analysis on the positions (coordinates) and pixel values (for example, luminance values) of predetermined characteristic portions (for example, an eye area, a nose tip, and a face line) of a plurality of sample face images. Using the AAM technique, any arbitrary target face image can be modeled (synthesized), and the positions of the characteristic portions in the target face image can be specified (detected) (for example, see JP-A-2007-141107).

In the AAM technique, however, it is desirable to improve the efficiency and the processing speed of specifying the predetermined characteristic portions of a face image.

In addition, it may also be desirable to improve efficiency and processing speed whenever image processing is performed for specifying the positions of predetermined characteristic portions of a face image.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

The present invention provides image processing apparatus and methods for specifying the positions of predetermined characteristic portions of a face image. Such image processing apparatus and methods may improve the efficiency and the speed of specifying the positions of predetermined portions of a face image.

Thus, in a first aspect, an image processing apparatus is provided that specifies a position of a predetermined characteristic portion of a target face image. The image processing apparatus includes an initial disposition unit, an image transforming unit, and an update unit. The initial disposition unit determines initial disposition of characteristic points in the target face image based on a result of comparing the target face image with each image of a reference face image group. The reference face image group can include a reference face image and N (here, N is an integer equal to or greater than one) types of transformed reference face images that are generated by performing a first transformation of N types on the reference face image. The reference face image can be created by performing a statistical analysis on a plurality of sample face images having known dispositions of the characteristic points representing the position of the characteristic portion. The image transforming unit performs a second transformation on at least one of the reference face image or the target face image such that the dispositions of the characteristic points of the reference face image and the target face image are identical to each other. The update unit updates the disposition of the characteristic points in the target face image based on a result of comparing the reference face image after the second transformation with the target face image.

In many embodiments, the initial disposition of the characteristic points in the target face image is determined based on the result of comparing the target face image with each image of the reference face image group. In many embodiments, the reference face image group is set in advance, and includes the reference face image and N types of transformed reference face images that are generated by performing a first transformation of N types on the reference face image. In many embodiments, the disposition of the characteristic points in the target face image is updated based on the result of comparing the reference face image after the second transformation with the target face image. Accordingly, by repeating the second transformation and update of the disposition of the characteristic points after determination on the initial disposition of the characteristic points, the positions of the characteristic portions in the target face image can be specified. As described above, by updating the disposition of the characteristic points after the initial disposition of the characteristic points in the target face image is determined based on the result of comparing the reference face image group with the target face image, the positions of the characteristic portions in the face image can be specified with excellent accuracy. In addition, in many embodiments, image transformation is not performed for the target image face when the initial disposition of the characteristic points is determined. Accordingly, the efficiency and processing speed of specifying the positions of the characteristic portions in the face image may be improved.

In many embodiments, the update unit includes a determination section that determines whether update of the disposition of the characteristic points in the target face image is to be performed based on the result of comparing the reference face image after the second transformation with the target face image.

In many embodiments, whether the disposition of the characteristic points is updated is determined based on the result of comparing the reference face image after the second transformation with the target face image. Accordingly, specifying of the positions of the characteristic portions in the face image can be performed with a desired accuracy.

In many embodiments, the first transformation of the N types is a transformation in which at least one of parallel movement, change in tilt, and enlargement or reduction of all the characteristic points in the reference face image is performed.

In many embodiments, the images in the reference face image group are created by performing transformation on the reference face image in which at least one of parallel movement, change in tilt, and enlargement or reduction of all the characteristic points is performed. Accordingly, the initial disposition of the characteristic points is determined by using the reference face image group having great variance in the entire disposition of the characteristic points. Therefore, the efficiency, the speed, and the accuracy of the process for specifying the positions of the characteristic portions in the target face image are improved.

In many embodiments, the image processing apparatus further includes a memory unit that stores model information that specifies a disposition model of the characteristic points and a linear combination of shape vectors representing characteristics of the disposition of the characteristic points in the plurality of sample face images. The disposition model of the characteristic points can be created by using statistical analysis in which an average shape is created that represents an average position of the characteristic points in the plurality of sample face images. The initial disposition unit can select one image from the reference face image group as a selected image based on a result of comparing each image of the reference face image group with the target face image. The initial disposition unit can determine the initial disposition of the characteristic points in the target face image based on a result of comparing the target face image with each image in a transformed selected images group. The transformed selected images group can be generated by applying a third transformation of M (here, M is an integer equal to or greater than one) types to the image selected from the reference face image group. The third transformation of M types can include changing at least one coefficient of a predetermined number of the shape vectors having the greatest variance in the disposition model for the image selected from the reference face image group.

In many embodiments, the third transformation of M types is generated by changing at least one coefficient of a predetermined number of the shape vectors having the greatest variance for the selected image. Accordingly, the initial disposition of the characteristic points may be set with higher accuracy. Therefore, the efficiency, the speed, and the accuracy of the process for specifying the positions of the characteristic portions in the face image may be improved.

In many embodiments, the reference face image is an average image of the plurality of sample face images. The disposition of the characteristic points in the reference face image can be identical to an average disposition of the characteristic points in the plurality of sample face images.

In many embodiments, the average face of the plurality of sample face images that is transformed such that the disposition of the characteristic points is identical to that of the average shape is used as the reference face image. Accordingly, the process for specifying the positions of the characteristic portions for all the face images can be efficiently performed with high accuracy at a high speed.

In many embodiments, the initial disposition unit determines the initial disposition of the characteristic points in the target face image based on the disposition of the characteristic points of an image, which is the closest to a predetermined area of the target face image, out of the reference face image group. Accordingly, the initial disposition of the characteristic points in the target face image can be determined with high accuracy.

In many embodiments, the image processing apparatus further includes a face-area detecting unit that detects a face area corresponding to a face image in the image. The predetermined area is an area for which relationship with the face area is set in advance.

In many embodiments, the initial disposition of the characteristic points is determined by detecting a face area and comparing an area, which is set in advance in relation to the face area, with the reference face image group. Accordingly, the initial disposition of the characteristic points in the target face image can be efficiently determined with high accuracy.

In another aspect, an image processing apparatus that specifies a position of a predetermined characteristic portion of a target face image is provided. The image processing apparatus includes a processor and a machine readable memory coupled with the processor. The machine readable memory includes instructions that when executed cause the processor to generate an initial disposition of characteristic points in the target face image in response to comparing each image of a plurality of images in a reference face image group with the target face image. The reference face image group can be generated by applying a first plurality of transformations to a reference face image having a known disposition of characteristic points. The instructions, when executed, further cause the processor to apply a second transformation to at least one of the reference face image and the reference face image characteristic points or the target face image and the target face image initial characteristic points such that the transformed target face image initial characteristic points match the reference face image characteristic points, or the transformed reference face image characteristic points match the target face image initial characteristic points. The instructions, when executed, further cause the processor to update the target face image initial characteristic points in response to a comparison between at least one of the reference face image and the target face image as transformed by the second transformation, or the target face image and the reference face image as transformed by the second transformation.

In many embodiments, the update of the target face image initial characteristic points is contingent on the results of at least one of a comparison between the reference face image and the target face image as transformed by the second transformation, or a comparison between the target face image and the reference face image as transformed by the second transformation.

In many embodiments, the first plurality of transformations comprises at least one of a parallel movement, a change in tilt, an enlargement, or a reduction of the reference face image characteristic points in the reference face image.

In many embodiments, the reference face image is generated from a plurality of sample face images. Each sample face image can have a known disposition of characteristic points.

In many embodiments, the image processing apparatus further includes a memory unit that stores a characteristic point disposition model comprising a sum of average positions of the characteristic points in the plurality of sample face images and a linear combination of shape vectors representing characteristics of the disposition of the characteristic points in the plurality of sample face images. One image in the reference face image group can be selected in response to a comparison between each image of the reference face image group with the target face image. A selected image group can be generated in response to the selected image of the reference face image group. The selected image group can be generated by applying a third plurality of transformations to the selected image of the reference face image group. The third plurality of transformations can include at least one coefficient of a predetermined number of the shape vectors having the greatest variance in the disposition model. The disposition of the target face image initial characteristic points can be generated in response to comparing each image of the selected image group with the target face image.

In many embodiments, the reference face image is generated by averaging the characteristic points of the sample face images.

In many embodiments, the target face image initial characteristic points are set to match the characteristic points of an image of the reference face image group that most closely corresponds to a predetermined area of the target face image.

In many embodiments, the image processing apparatus further includes a face-area detecting unit that detects a face area corresponding to a face image in the target face image. The predetermined area can be an area for which relationship with the face area is set in advance.

In addition, the invention can be implemented in various forms. For example, the invention can be implemented in the forms of an image processing method, an image processing apparatus, a characteristic position specifying method, a characteristic position specifying apparatus, a facial-expression determining method, a facial-expression determining apparatus, a computer program for implementing the functions of the above-described method or apparatus, a recording medium having the computer program recorded thereon, a data signal implemented in a carrier wave including the computer program, and the like.

For a fuller understanding of the nature and advantages of the present invention, reference should be made to the ensuing detailed description and accompanying drawings.

### BRIEF DESCRIPTION OF THE DRAWINGS

The invention is described with reference to the accompanying drawings, wherein like numbers reference like elements.

FIG. 1 is an explanatory diagram schematically showing the configuration of a printer as an image processing apparatus in accordance with many embodiments.

FIG. 2 is a flowchart showing steps in an active appearance model technique in accordance with many embodiments.

FIG. 3 is an explanatory diagram showing exemplary sample face images.

FIG. 4 is an explanatory diagram illustrating a method of setting characteristic points of a sample face image, in accordance with many embodiments.

FIG. 5 is an explanatory diagram showing coordinates of the characteristic points set in the sample face image of FIG. 4.

FIGS. 6A and 6B are explanatory diagrams showing an average face shape, in accordance with many embodiments.

FIG. 7 is an explanatory diagram illustrating a warp method for a sample face image, in accordance with many embodiments.

FIG. 8 is an explanatory diagram showing an exemplary average face image.

FIG. 9 is a flowchart showing steps in a face characteristic position specifying process, in accordance with many embodiments.

FIG. 10 is an explanatory diagram showing the detection of a face area in a target face image, in accordance with many embodiments.

FIG. 11 is a flowchart showing steps of an initial disposition determining process for characteristic points, in accordance with many embodiments.

FIGS. 12A and 12B are explanatory diagrams showing exemplary transformed average face images.

FIG. 13 is an explanatory diagram showing an exemplary initial disposition of characteristic points in a target face image.

FIG. 14 is a flowchart showing steps of an update process for the disposition of characteristic points, in accordance with many embodiments.

FIG. 15 is an explanatory diagram showing an exemplary result of a face characteristic position specifying process.

FIG. 16 is a flowchart showing steps of an alternate initial disposition determining process for characteristic points, in accordance with many embodiments.

FIGS. 17A and 17B are explanatory diagrams showing exemplary temporary disposition of characteristic points in a target face image, in accordance with many embodiments.

FIG. 18 is an explanatory diagram showing exemplary average shape images, in accordance with many embodiments.

FIG. 19 is a flowchart showing steps of an initial disposition determining process for characteristic points, in accordance with many embodiments.

### DETAILED DESCRIPTION

In the following description, various embodiments of the present invention are described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

### Image Processing Apparatus

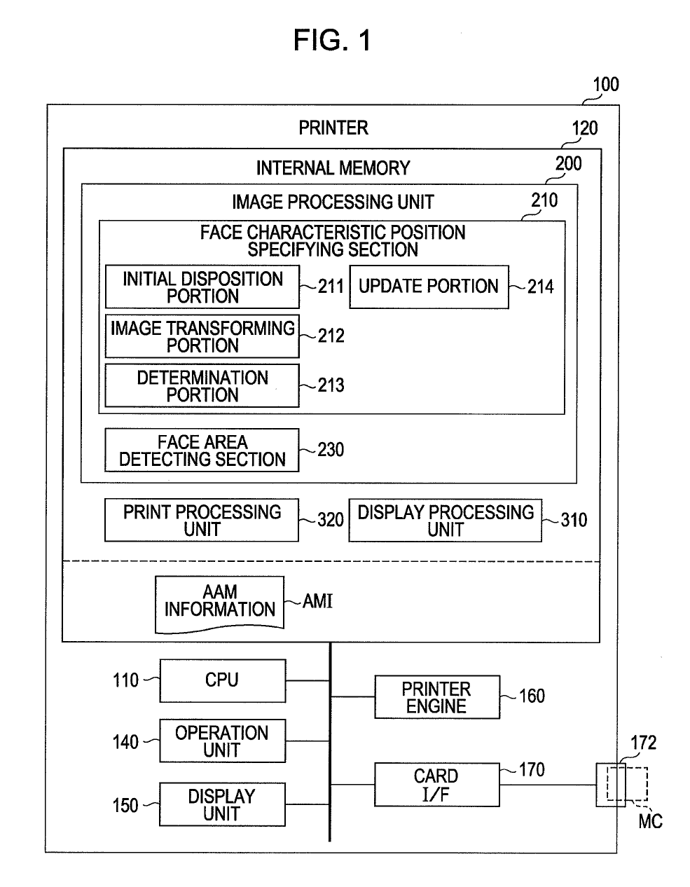

Referring now to the drawings, in which like reference numerals represent like parts throughout the several views, FIG. 1 is an explanatory diagram schematically showing the configuration of a printer 100 as an image processing apparatus, in accordance with many embodiments. The printer 100 can be a color ink jet printer corresponding to so-called direct printing in which an image is printed based on image data that is acquired from a memory card MC or the like. The printer 100 includes a CPU 110 that controls each unit of the printer 100, an internal memory 120 that includes a read-only memory (ROM) and a random-access memory (RAM), an operation unit 140 that can include buttons and/or a touch panel, a display unit 150 that can include a display (e.g., a liquid crystal display), a printer engine 160, and a card interface (card I/F) 170. In addition, the printer 100 can include an interface that is used for performing data communication with other devices (for example, a digital camera or a personal computer). The constituent elements of the printer 100 are interconnected through a communication bus.

The printer engine 160 is a printing mechanism that performs a printing operation based on the print data. The card interface 170 is an interface that is used for exchanging data with a memory card MC inserted into a card slot 172. In many embodiments, an image file that includes the image data is stored in the memory card MC.

In the internal memory 120, an image processing unit 200, a display processing unit 310, and a print processing unit 320 are stored. The image processing unit 200 can be a computer program for performing a face characteristic position specifying process under a predetermined operating system. The face characteristic position specifying process specifies (detects) the positions of predetermined characteristic portions (for example, an eye area, a nose tip, or a face line) in a face image. The face characteristic specifying process is described below in detail.

The image processing unit 200 includes a face characteristic position specifying section 210 and a face area detecting section 230 as program modules. The face characteristic position specifying section 210 includes an initial disposition portion 211, an image transforming portion 212, a determination portion 213, and an update portion 214. The functions of these portions are described in detail in a description of the face characteristic position specifying process described below.

The display processing unit 310 can be a display driver that displays a process menu, a message, an image, and/or the like on the display unit 150 by controlling the display unit 150. The print processing unit 320 can be a computer program that generates print data based on the image data and prints an image based on the print data by controlling the printer engine 160. The CPU 110 implements the functions of these units by reading out the above-described programs (the image processing unit 200, the display processing unit 310, and the print processing unit 320) from the internal memory 120 and executing the programs.

In addition, AAM information AMI is stored in the internal memory 120. The AAM information AMI is information that is set in advance in an AAM setting process described below and is referred to in the face characteristic position specifying process described below. The content of the AAM information AMI is described in detail in a description of the AAM setting process provided below.

### AAM Setting Process

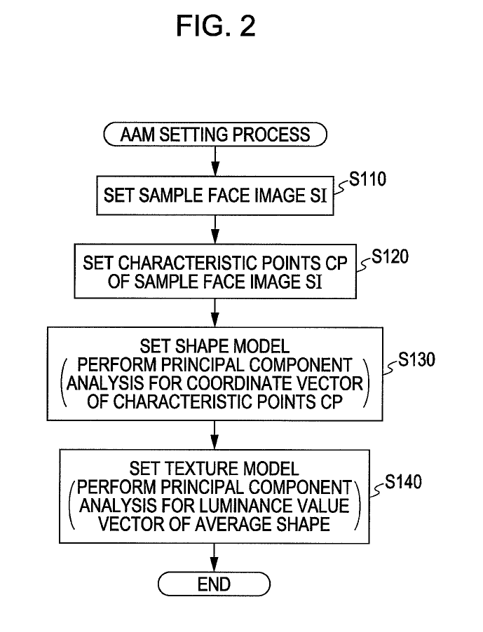

FIG. 2 is a flowchart showing steps of an AAM setting process in accordance with many embodiments. The AAM setting process creates shape and texture models that are used in an image modeling technique called an Active Appearance Model (AAM).

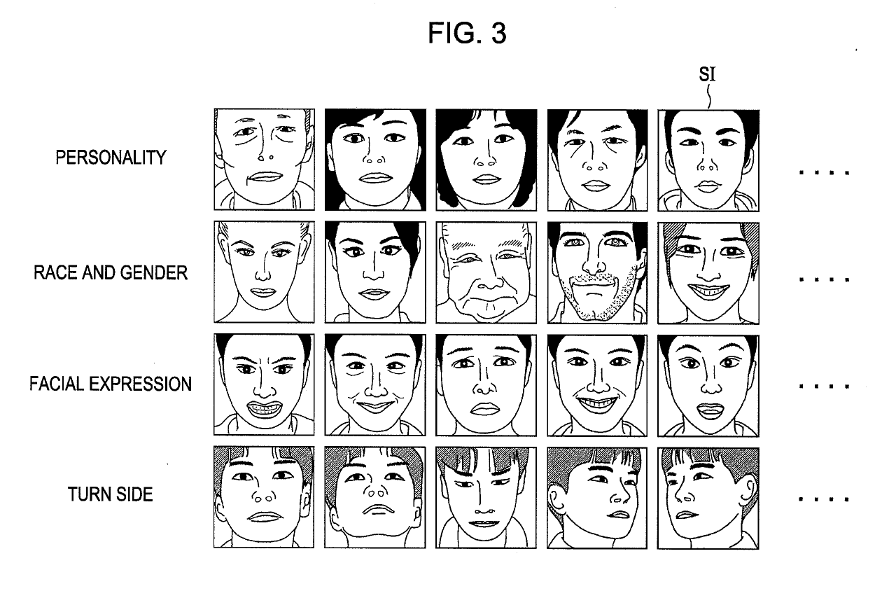

In Step S110, a plurality of images representing people's faces are set as sample face images SI. FIG. 3 is an explanatory diagram showing exemplary sample face images SI. As illustrated in FIG. 3, the sample face images SI can be set such that the sample face images SI have different attributes for various attributes such as personality, race, gender, facial expression (anger, laugh, troubled, surprise, or the like), and a direction (front-side turn, upward turn, right-side turn, left-side turn, or the like). When the sample face images SI are set in such a manner, a wide variety of face images can be modeled with high accuracy by using the AAM technique. Accordingly, the face characteristic position specifying process (described below) can be performed with high accuracy for a wide variety of face images. The sample face images SI are also referred to herein as learning face images.

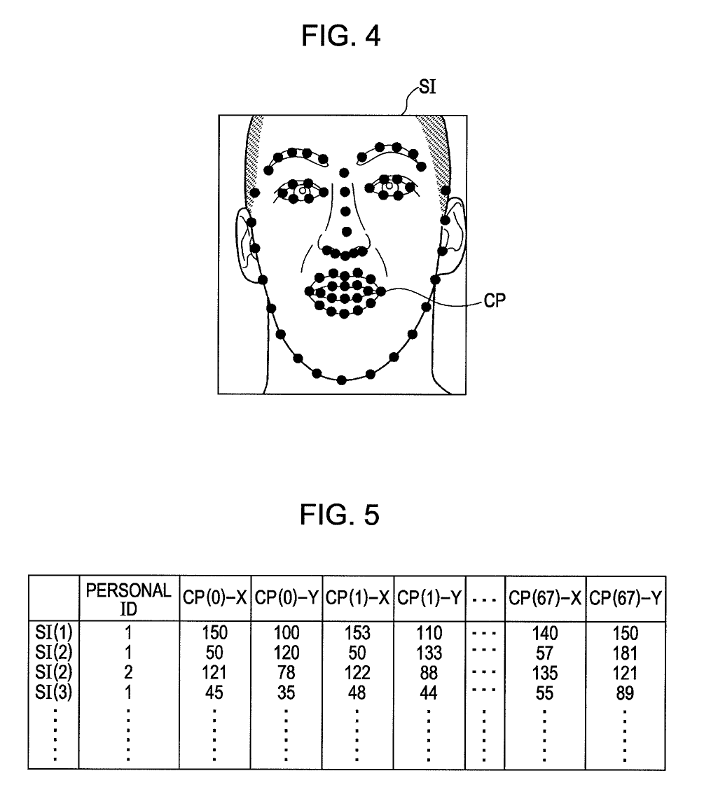

In Step S120 (FIG. 2), the characteristic points CP are set for each sample face image SI. FIG. 4 is an explanatory diagram illustrating the setting of characteristic points CP of a sample face image SI. The characteristic points CP are points that represent the positions of predetermined characteristic portions of the face image. In many embodiments, 68 characteristic points CP are located on portions of a person's face that include predetermined positions on the eyebrows (for example, end points, four-division points, or the like; the same in description below), predetermined positions on the contour of the eyes, predetermined positions on contours of the bridge of the nose and the wings of the nose, predetermined positions on the contours of upper and lower lips, and predetermined positions on the contour (face line) of the face. In other words, predetermined positions of contours of organs (eyebrows, eyes, a nose, and a mouth) of a face and the face that are commonly included in a person's face are set as the characteristic portions. As shown in FIG. 4, the characteristic points CP can be set (disposed) to the illustrated 68 positions that represent characteristic portions of each sample face image SI. The characteristic points can be designated, for example, by an operator of the image processing apparatus. The characteristic points CP correspond to the characteristic portions, and accordingly it can be represented that the disposition of the characteristic points CP in a face image specifies the shape of the face.

The position of each characteristic point CP in a sample face image SI can be specified by coordinates. FIG. 5 is an explanatory diagram showing exemplary coordinates of the characteristic points CP set in the sample face image SI. In FIG. 5, SI(j) (j=1, 2, 3 . . . ) represents each sample face image SI, and CP(k) (k=0, 1, . . . , 67) represents each characteristic point CP. In addition, CP(k)-X represents the X coordinate of the characteristic point CP(k), and CP(k)-Y represents the Y coordinate of the characteristic point CP(k). The coordinates of the characteristic point CP can be set by using a predetermined reference point (for example, a lower left point in an image) in a sample face image SI that has been normalized for the face size, the face tilt (a tilt within the image surface), and the positions of the face in the X direction and the Y direction used. In addition, a case where a plurality of person's images is included in one sample face image SI is allowed (for example, two faces are included in a sample face image SI(2)), and the persons included in one sample face image SI are specified by personal IDs.

In Step S130 (FIG. 2), a shape model of the AAM is set. In particular, the face shape S that is specified by the positions of the characteristic points CP is modeled by the following Equation (1) by performing a principal component analysis for a coordinate vector (see FIG. 5) that is configured by the coordinates (X coordinates and Y coordinates) of 68 characteristic points CP in each sample face image SI. In addition, the shape model is also called a disposition model of characteristic points CP.

$$\begin{matrix}Equation ( 1 ) & \\ s = {s}_{0} + {\sum }_{i = 1}^{n} {p}_{i} {s}_{i} & ( 1 )\end{matrix}$$

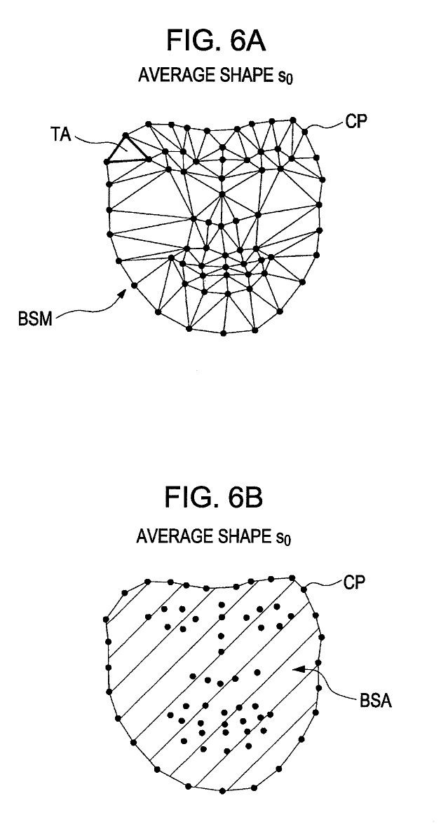

In the above-described Equation (1), s₀ is an average shape. FIGS. 6A and 6B are explanatory diagrams showing an example of the average shape s₀. As shown in FIGS. 6A and 6B, the average shape s₀ is a model that represents an average face shape that is specified by average positions (average coordinates) of each characteristic point CP of the sample face image SI. An area (denoted by being hatched in FIG. 6B) surrounded by straight lines enclosing characteristic points CP (characteristic points CP corresponding to the face line, the eyebrows, and a region between the eyebrows; see FIG. 4) located on the outer periphery of the average shape s₀ is referred to herein as an “average shape area BSA”. The average shape s₀ is set such that, as shown in FIG. 6A, a plurality of triangle areas TA having the characteristic points CP as vertexes divides the average shape area BSA into mesh shapes. Here, a mesh of the average shape s₀ that is configured by the characteristic points CP and the outline of the triangle areas TA is referred to herein as an “average shape mesh BSM”.

In the above-described Equation (1) representing a shape model, sᵢ is a shape vector, and pᵢ is a shape parameter that represents the weight of the shape vector sᵢ. The shape vector sᵢ is a vector that represents the characteristics of the face shape S. In particular, the shape vector sᵢ can be an eigenvector corresponding to an i-th principal vector acquired by performing principal component analysis. In many embodiments, n eigenvectors that are set based on the accumulated contribution rates in the order of eigenvectors corresponding to principal components having greater variance are used as the shape vectors sᵢ. In many embodiments, a first shape vector sᵢ that corresponds to a first principal component having the greatest variance becomes a vector that is approximately correlated with the horizontal appearance of a face, and a second shape vector s₂ corresponding to a second principal component that has the second greatest variance is a vector that is approximately correlated with the vertical appearance of a face. In many embodiments, a third shape vector s₃ corresponding to a third principal component having the third greatest variance becomes a vector that is approximately correlated with the aspect ratio of a face, and a fourth shape vector s₄ corresponding to a fourth principal component having the fourth greatest variance becomes a vector that is approximately correlated with the degree of opening of a mouth.

As shown in the above-described Equation (1), a face shape S that represents the disposition of the characteristic points CP can be modeled as a sum of an average shape s₀ and a linear combination of n shape vectors sᵢ. By appropriately setting the shape parameter pᵢ for the shape model, the face shape S in a wide variety of images can be reproduced. In many embodiments, the average shape s₀ and the shape vector sᵢ that are set in the shape model setting step (Step S130 in FIG. 2) are stored in the internal memory 120 as the AAM information AMI (FIG. 1). The average shape s₀ and the shape vector sᵢ as the AAM information AMI are also referred to herein as model information.

In Step S140 (FIG. 2), a texture model of the AAM is set. In many embodiments, the process of setting the texture model begins by applying an image transformation (hereinafter, also referred to herein as “warp W”) to each sample face image SI, so that the disposition of the characteristic points CP in each of the transformed sample images SI is identical to that of the disposition of the characteristic points CP in the average shape s₀.

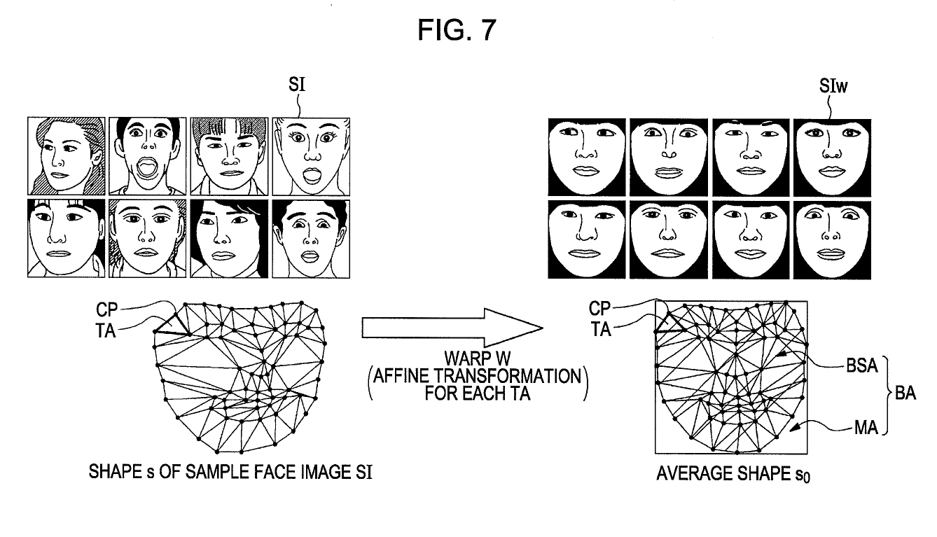

FIG. 7 is an explanatory diagram showing an example of a warp W method for a sample face image SI. For each sample face image SI, similar to the average shape s₀, a plurality of triangle areas TA that divides an area surrounded by the characteristic points CP located on the outer periphery into mesh shapes is set. The warp W is an affine transformation set for each of the plurality of triangle areas TA. In other words, in the warp W, an image of triangle areas TA in a sample face image SI is transformed into an image of corresponding triangle areas TA in the average shape s₀ by using the affine transformation method. By using the warp W, a transformed sample face image SI (hereinafter, referred to as a “sample face image SIw”) having the same disposition of the characteristic points CP as that of the average shape s₀ is generated.

In addition, each sample face image SIw is generated as an image in which an area (hereinafter, also referred to as a “mask area MA”) other than the average shape area BSA is masked by using the rectangular range including the average shape area BSA (denoted by being hatched in FIG. 7) as the outer periphery. An image area acquired by summing the average shape area BSA and the mask area MA is referred to herein as a reference area BA. In many embodiments, each sample face image SIw is normalized, for example, as an image having the size of 56 pixels×56 pixels.

Next, the texture (also referred to herein as an “appearance”) A(x) of a face is modeled by using the following Equation (2) by performing principal component analysis for a luminance value vector that includes luminance values for each pixel group x of each sample face image SIw. In many embodiments, the pixel group x is a set of pixels that are located in the average shape area BSA.

$$\begin{matrix}Equation ( 2 ) & \\ A ( x ) = {A}_{0} ( x ) + {\sum }_{i = 1}^{m} {λ}_{i} {A}_{i} ( x ) & ( 2 )\end{matrix}$$

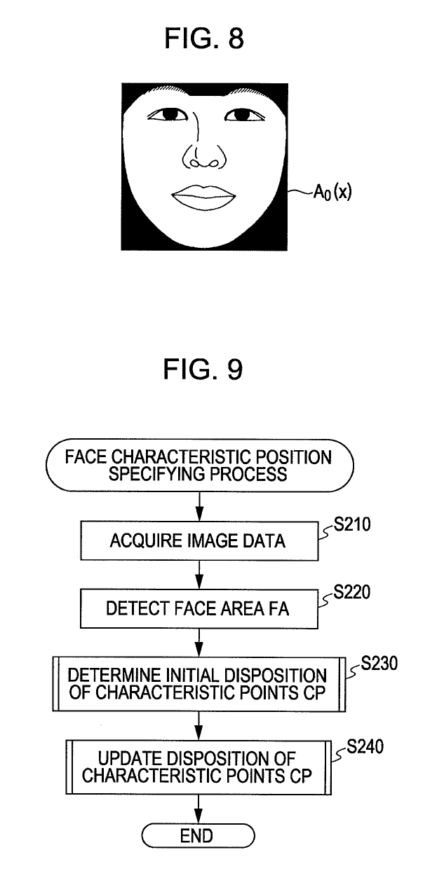

In the above-described Equation (2), A₀(x) is an average face image. FIG. 8 is an explanatory diagram showing an example of the average face image A₀(x). The average face image A₀(x) is an average face of sample face images SIw (see FIG. 7) after the warp W. In other words, the average face image A₀(x) is an image that is calculated by taking an average of pixel values (luminance values) of pixel groups x located within the average shape area BSA of the sample face image SIw. Accordingly, the average face image A₀(x) is a model that represents the texture of an average face in the average face shape. In addition, the average face image A₀(x), similarly to the sample face image SIw, includes an average shape area BSA and a mask area MA and, for example, is calculated as an image having the size of 56 pixels×56 pixels. The average face image A₀(x) is also referred to as a reference face image.

In the above-described Equation (2) representing a texture model, Aᵢ(x) is a texture vector, λᵢ is a texture parameter that represents the weight of the texture vector Aᵢ(x). The texture vector Aᵢ(x) is a vector that represents the characteristics of the texture A(x) of a face. In many embodiments, the texture vector Aᵢ(x) is an eigenvector corresponding to an i-th principal component that is acquired by performing principal component analysis. In many embodiments, m eigenvectors set based on the accumulated contribution rates in the order of the eigenvectors corresponding to principal components having greater variance are used as a texture vector Aᵢ(x). In many embodiments, the first texture vector A₁(x) corresponding to the first principal component having the greatest variance becomes a vector that is approximately correlated with a change in the color of a face (may be perceived as a difference in gender).

As shown in the above-described Equation (2), the face texture A(x) representing the outer appearance of a face can be modeled as a sum of the average face image A₀(x) and a linear combination of m texture vectors Aᵢ(x). By appropriately setting the texture parameter λᵢ in the texture model, the face textures A(x) for a wide variety of images can be reproduced. In addition, in many embodiments, the average face image A₀(x) and the texture vector Aᵢ(x) that are set in the texture model setting step (Step S140 in FIG. 2) are stored in the internal memory 120 as the AAM information AMI (FIG. 1).

By performing the above-described AAM setting process (FIG. 2), a shape model that models a face shape and a texture model that models a face texture are set. By combining the shape model and the texture model that have been set, that is, by performing transformation (an inverse transformation of the warp W shown in FIG. 7) from the average shape s₀ into a shape S for the synthesized texture A(x), the shapes and the textures of a wide variety of face images can be reproduced.

### Face Characteristic Position Specifying Process

FIG. 9 is a flowchart showing the steps of a face characteristic position specifying process, in accordance with many embodiments. The face characteristic position specifying process specifies the positions of characteristic portions of a face included in a target face image by determining the disposition of the characteristic points CP in the target face image by using the AAM technique. As described above, a total of 68 predetermined positions of a person's face organs (the eyebrows, the eyes, the nose, and the mouth) and the contour of the face are set as the characteristic portions (see FIG. 4) in the AAM setting process (FIG. 2). Accordingly, the disposition of 68 characteristic points CP that represent predetermined positions of the person's face organs and the contour of the face is determined.

When the disposition of the characteristic points CP in the target face image is determined by performing the face characteristic position specifying process, the shapes and the positions of the face organs of a person and the contour shape of the face that are included in a target face image can be specified. Accordingly, the result of the face characteristic position specifying process can be used in an expression determination process for detecting a face image having a specific expression (for example, a smiling face or a face with closed eyes), a face-turn direction determining process for detecting a face image positioned in a specific direction (for example, a direction turning to the right side or a direction turning to the lower side), a face transformation process for transforming the shape of a face, or the like.

In Step S210 (FIG. 9), the image processing unit 200 (FIG. 1) acquires image data representing a target face image that becomes a target for the face characteristic position specifying process. For example, when the memory card MC is inserted into the card slot 172 of the printer 100, a thumbnail image of the image file that is stored in the memory card MC can be displayed in the display unit 150. A user can select one or a plurality of images that becomes the processing target through the operation unit 140 while referring to the displayed thumbnail image. The image processing unit 200 acquires the image file that includes the image data corresponding to one or the plurality of images that has been selected from the memory card MC and stores the image file in a predetermined area of the internal memory 120. Here, the acquired image data is referred to herein as target face image data, and an image represented by the target face image data is referred to herein as a target face image OI.

In Step S220 (FIG. 9), the face area detecting section 230 (FIG. 1) detects a predetermined area corresponding to a face image in the target face image OI as a face area FA. The detecting of the face area FA can be performed by using a known face detecting technique. Such known face detecting techniques include, for example, a technique using pattern matching, a technique using extraction of a skin-color area, a technique using learning data that is set by learning (for example, learning using a neural network, learning using boosting, learning using a support vector machine, or the like) using sample face images, and the like.

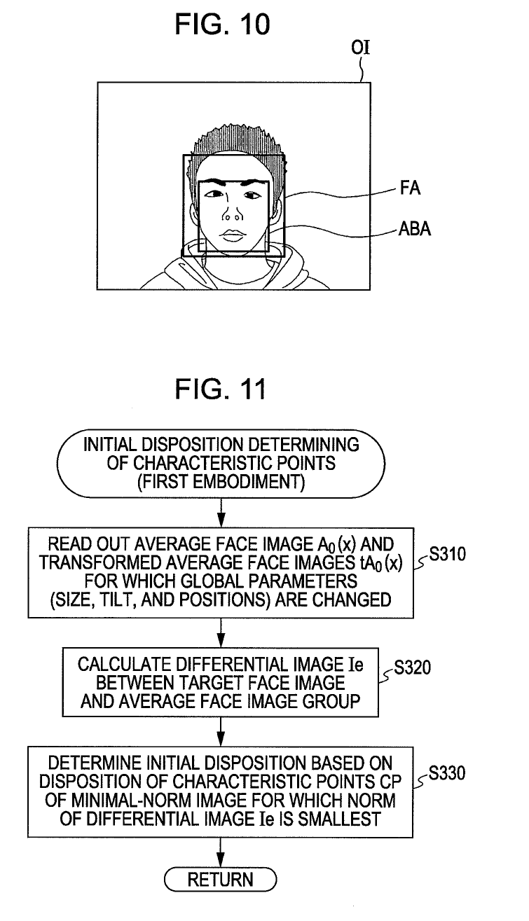

FIG. 10 is an explanatory diagram showing an example of the result of detecting the face area FA in the target face image OI. In FIG. 10, a face area FA that is detected from the target face image OI is shown. In many embodiments, a face detecting technique is used that detects a rectangle area that approximately includes from the forehead to the chin in the vertical direction of the face and approximately includes the outer sides of both the ears in the horizontal direction as the face area FA.

In addition, an assumed reference area ABA shown in FIG. 10 is an area that is assumed to be in correspondence with the reference area BA (see FIG. 7) that is the entire area of the sample face image SIw and the average face image A₀(x). The assumed reference area ABA is set as an area, which has predetermined relationship with the face area FA for the size, the tilt, and the positions located in the upper, lower, left and right sides, based on the detected face area FA. The predetermined relationship between the face area FA and the assumed reference area ABA is set in advance in consideration of the characteristics (the range of a face detected as the face area FA) of the face detecting technique used in detecting the face area FA such that the assumed reference area ABA corresponds to the reference area BA for a case where the face represented in the face area FA is an average face.

In Step S230 (FIG. 9), the face characteristic position specifying section 210 (FIG. 1) determines the initial disposition of the characteristic points CP in the target face image OI. FIG. 11 is a flowchart showing the flow of an initial disposition determining process for the characteristic points CP, in accordance with many embodiments. In many embodiments, a reference face image group is created in advance and stored in the internal memory 120 as the AMM information AMI (FIG. 1). In many embodiments, the reference face image group includes a plurality of different reference face images. Each reference face image can have a known disposition of characteristic points CP. In many embodiments, the reference face image group includes the above-described average face image A₀(x) (see FIG. 8) and a plurality of transformed average face images tA₀(x), each of which can be created by applying a different transformation to the average face image A₀(x). For example, in many embodiments, the plurality of transformed average face images tA₀(x) are created via changing a global parameter of the average face image A₀(x) as described below.

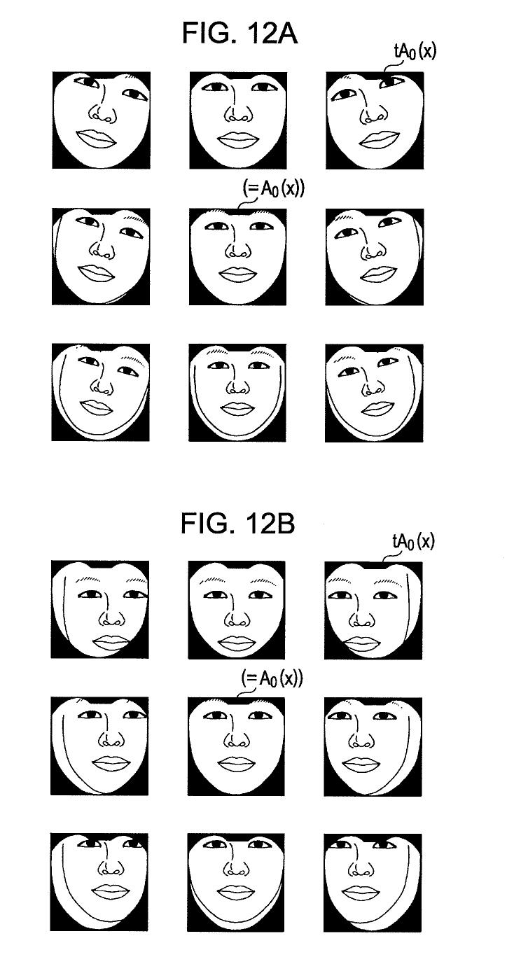

FIGS. 12A and 12B are explanatory diagrams showing exemplary transformed average face images tA₀(x). A transformed average face image tA₀(x) is an image acquired by performing transformation for changing a global parameter for at least one of the size, the tilt, and the positions (the positions in the upper and lower sides and the positions in the left and right sides) of the average face image A₀(x). In many embodiments, as shown in FIG. 12A, the transformed average face images tA₀(x) include an image (an image shown above or below the average face image A₀(x)) that is acquired by enlarging or reducing an image within the average shape area BSA (see FIG. 6B) of the average face image A₀(x), shown on the center, by a predetermined scaling factor and an image (an image shown on the left side or the right side of the average face image A₀(x)) that is acquired by changing the tilt of the image by a predetermined angle in the clockwise direction or the counterclockwise direction. In many embodiments, the transformed average face images tA₀(x) include an image (an image shown on the upper left side, the lower left side, the upper right side, or the lower right side of the average face image A₀(x)) that is acquired by performing transformation that combines enlargement or reduction and a change in the tilt of the image within the average shape area BSA of the average face image A₀(x).

In many embodiments, as shown in FIG. 12B, the transformed average face images tA₀(x) include an image (an image shown below or above the average face image A₀(x)) acquired by moving the image within the average shape area BSA (see FIG. 6B) of the average face image A₀(x) to the upper side or the lower side in a parallel manner or an image (an image shown on the right side or the left side of the average face image A₀(x)) acquired by moving the image within the average shape area BSA to the left side or the right side by a predetermined amount in a parallel manner. In many embodiments, the transformed average face images tA₀(x) include an image (an image shown on the upper left side, the lower left side, the upper right side, or the lower right side of the average face image A₀(x)) acquired by performing transformation that combines parallel movement of the image within the average shape area BSA of the average face image A₀(x) to the upper side or the lower side and parallel movement of the image within the average shape area BSA to the left side or the right side.

Furthermore, the transformed average face images tA₀(x) include images acquired by performing parallel movement to the upper side, the lower side, the left side, or the right side shown in FIG. 12B for eight transformed average face images tA₀(x) shown in FIG. 12A. Accordingly, in many embodiments, by performing transformation of a total of 80 types (=3×3×3×3−1) corresponding to combinations of three levels for each of four global parameters (the size, the tilt, the positions in the vertical direction, and the positions in the horizontal direction) for the average face image A₀(x), a total of 80 types of the transformed average face images tA₀(x) are generated and set. The transformation of the total of 80 types is an example of what is also referred to herein as a first transformation of N types. In addition, the average face image A₀(X) can be regarded as an image that is acquired by performing a transformation, of which the adjust amount is zero for all the four global parameters, for the average face image A₀(x). In such a case, it can be represented that a total of 81 types of the transformed average face images tA₀(x) are set by performing transformations of a total of 81 types (=3×3×3×3).

In addition, the dispositions of the characteristic points CP in the transformed average face images tA₀(x) are uniquely determined by the transformations that are performed for the average face image A₀(x) for generating the transformed average face images tA₀(x). The information representing the disposition of the characteristic points CP in each transformed average face image tA₀(x) is stored in the internal memory 120 as the AAM information AMI (FIG. 1).

The transformed average face images tA₀(x) are also referred to herein as transformed reference face images. In addition, an image group (hereinafter, also referred to as an “average face image group”) that includes the average face image A₀(x) and the transformed average face images tA₀(x) are also referred to herein as a reference face image group.

In Step S310 of the initial disposition determining process (FIG. 11) for the characteristic points CP, the initial disposition portion 211 (FIG. 1) reads out the average face image A₀(x) and the transformed average face images tA₀(x) as AAM information AMI.

In Step S320 (FIG. 11), the initial disposition portion 211 (FIG. 1) calculates differential images Ie between the assumed reference area ABA (FIG. 10) of the target face image OI and the average face image group. In many embodiments, a differential image Ie is the difference in luminance values between two images. Since the average face image group is configured by one average face image A₀(x) and 80 transformed average face images tA₀(x), the initial disposition portion 211 calculates 81 differential images Ie. The assumed reference area ABA of the target face image OI is also referred to herein as a predetermined area.

In Step S330 (FIG. 11), the initial disposition portion 211 (FIG. 1) calculates norms of the differential images Ie and selects an image (hereinafter, also referred to as a “minimal norm image”) corresponding to the differential image Ie having the smallest value of the norm from the average face image group. The minimal norm image is an image closest to the assumed reference area ABA (FIG. 10) of the target face image OI. The initial disposition portion 211 determines the initial disposition of the characteristic points CP of the target face image OI based on the disposition of the characteristic points CP in the minimal norm image. In particular, the disposition of the characteristic points CP in the minimal norm image in a case where the minimal norm image is overlapped with the assumed reference area ABA of the target face image OI is determined to be the initial disposition of the characteristic points CP in the target face image OI. By performing the initial disposition process for the characteristic points CP, approximate values of the global parameters, which define the size, the tilt, and the positions (the positions on the upper and lower sides and the positions on the left and right sides) of the disposition of the characteristic points CP of the target face image OI on the whole, are set.

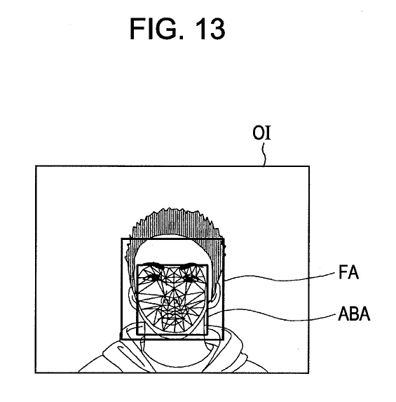

FIG. 13 is an explanatory diagram showing an example of the initial disposition of the characteristic points CP in the target face image OI. In FIG. 13, the initial disposition of the characteristic points CP determined for the target face image OI is represented by meshes. In other words, intersections of the meshes are the characteristic points CP. This mesh is in a scaling relationship with the average shape mesh BSM of the average shape s₀.

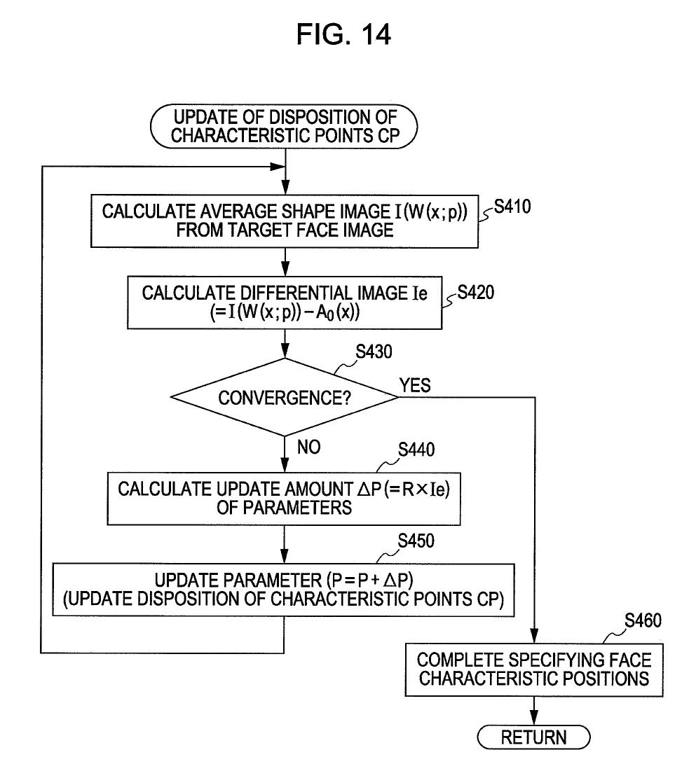

When the initial disposition determining process (Step S230 shown in FIG. 9) for the characteristic points CP is completed, the face characteristic position specifying section 210 (FIG. 1) updates the characteristic points CP of the target face image OI (Step S240). FIG. 14 is a flowchart showing the flow of an update process for the disposition of the characteristic points CP, in accordance with many embodiments.

In Step S410, the image transforming portion 212 (FIG. 1) creates an average shape image I(W(x;p)) from the target face image OI. The average shape image I(W(x;p) is a face image transformed to have the average shape s₀. The average shape image I(W(x;p)) is calculated by performing a transformation in which the disposition of the characteristic points CP of the transformed image is identical to the disposition (see FIGS. 6A and 6B) of the characteristic points CP of the average shape s₀. This transformation is also referred to herein as a second transformation.

The transformation for creating the average shape image I(W(x;p)), similarly to the transformation (see FIG. 7) for creating the sample face image SIw, is performed by a warp W that is an affine transformation set for each triangle area TA. In many embodiments, the average shape image I(W(x;p)) is created by specifying the average shape area BSA (an area surrounded by the characteristic points CP that are located on the outer periphery) by the characteristic points CP (see FIG. 13) disposed on the target face image OI and performing the affine transformation for each triangle area TA of the average shape area BSA of the target face image OI. In many embodiments, the average shape image I(W(x;p)), similarly to the average face image A₀(x), is configured by an average shape area BSA and a mask area MA and is acquired as an image having the same size as that of the average face image A₀(x).

In addition, as described above, a pixel group x is a set of pixels located in the average shape area BSA of the average shape s₀. The pixel group of an image (the average shape area BSA of the target face image OI), for which the warp W has not been performed, corresponding to the pixel group x of an image (a face image having the average shape s₀) for which the warp W has been performed is denoted as W(x;p). The average shape image is an image that is configured by luminance values for each pixel group W(x;p) in the average shape area BSA of the target face image OI. Thus, the average shape image is denoted by I(W(x;p)).

In Step S420 (FIG. 14), the face characteristic position specifying section 210 (FIG. 1) calculates a differential image Ie between the average shape image I(W(x;p)) and the average face image A₀(x). In Step S430, the determination portion 213 (FIG. 1) determines whether the disposition update process for the characteristic points CP converges based on the differential image Ie. The determination portion 213 calculates a norm of the differential image Ie. Then, in many embodiments, in a case where the value of the norm is less than a threshold value set in advance, the determination portion 213 determines convergence. In many embodiments, in a case where the value of the norm is equal to or greater than the threshold value, the determination portion 213 determines no convergence. In addition, the determination portion 213 can be configured to determine convergence for a case where the value of the norm of the calculated differential image Ie is less than a value calculated in Step S430 at the previous time and determine no convergence for a case where the value of the norm of the calculated differential image Ie is equal to or greater than the previous value. Alternatively, the determination portion 213 can be configured to determine convergence by combining the determination made based on the threshold value and the determination made based on the previous value. For example, the determination portion 213 can be configured to determine convergence only for cases where the value of the calculated norm is less than the threshold value and is less than the previous value and determine no convergence for other cases.

When no convergence is determined in the transformation determination of Step S430, the update portion 214 (FIG. 1) calculates an update amount ΔP of the parameters (Step S440). In many embodiments, the update amount ΔP of the parameter represents the amount of change in the values of the four global parameters (the overall size, the tilt, the X-direction position, and the Y-direction position) and n shape parameters pᵢ (see Equation (1)). In addition, in many embodiments, right after the initial disposition of the characteristic points CP, the global parameters are set to values determined in the initial disposition determining process (FIG. 11) for the characteristic points CP. In such embodiments, a difference between the initial disposition of the characteristic points CP and the characteristic points CP of the average shape s₀ is limited to differences in the overall size, the tilt, and the positions. Accordingly, in such embodiments, all the values of the shape parameters pᵢ of the shape model are zero.

The update amount ΔP of the parameters is calculated by using the following Equation (3). In many embodiments, the update amount ΔP of the parameters is the product of an update matrix R and the difference image Ie.

ΔP=R×Ie Equation (3)

The update matrix R represented in Equation (3) is a matrix of M rows×N columns that is set by learning in advance for calculating the update amount ΔP of the parameters based on the differential image Ie and is stored in the internal memory 120 as the AAM information AMI (FIG. 1). In many embodiments, the number M of the rows of the update matrix R is identical to a sum (4+n) of the number (4) of the global parameters and the number (n) of the shape parameters pᵢ, and the number N of the columns is identical to the number (56 pixels×56 pixels-number of pixels included in the mask area MA) within the average shape area BSA of the average face image A₀(x) (FIGS. 6A and 6B). In many embodiments, the update matrix R is calculated by using the following Equations (4) and (5).

$$\begin{matrix}Equation ( 4 ) & \\ R = {H}^{- 1} \sum {[ ∇ {A}_{0} \frac{\partial W}{\partial P} ]}^{T} & ( 4 ) \\ Equation ( 5 ) & \\ H = \sum {[ ∇ {A}_{0} \frac{\partial W}{\partial P} ]}^{T} [ ∇ {A}_{0} \frac{\partial W}{\partial P} ] & ( 5 )\end{matrix}$$

Equations (4) and (5), as well as active models in general, are described in Matthews and Baker, “Active Appearance Models Revisited,” tech. report CMU-RI-TR-03-02, Robotics Institute, Carnegie Mellon University, April 2003, the full disclosure of which is hereby incorporated by reference.

In Step S450 (FIG. 14), the update portion 214 (FIG. 1) updates the parameters (four global parameters and n shape parameters pᵢ) based on the calculated update amount ΔP of the parameters. Accordingly, the disposition of the characteristic points CP of the target face image OI is updated. After update of the parameters is performed in Step S450, again, the average shape image I(W(x;p)) is calculated from the target face image OI for which the disposition of the characteristic points CP has been updated (Step S410), the differential image Ie is calculated (Step S420), and a convergence determination is made based on the differential image Ie (Step S430). In a case where no convergence is determined in the convergence determination performed again, additionally, the update amount ΔP of the parameters is calculated based on the differential image Ie (Step S440), and disposition update of the characteristic points CP by updating the parameters is performed (Step S450).

When the process from Step S410 to Step S450 in FIG. 14 is repeatedly performed, the positions of the characteristic points CP corresponding to the characteristic portions of the target face image OI approach the positions (correct positions) of actual characteristic portions as a whole. Then, the convergence is determined in the convergence determination (Step S430) at a time point. When the convergence is determined in the convergence determination, the face characteristic position specifying process is completed (Step S460). The disposition of the characteristic points CP specified by the values of the global parameters and the shape parameters pᵢ that are set at that moment is determined to be the final disposition of the characteristic points CP of the target face image OI.

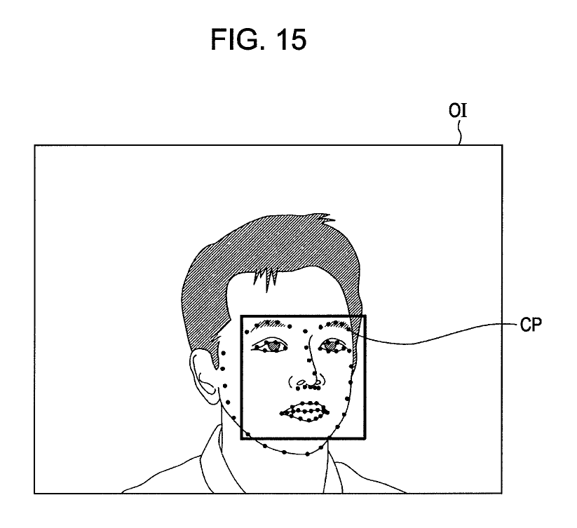

FIG. 15 is an explanatory diagram showing an example of the result of the face characteristic position specifying process. In FIG. 15, the disposition of the characteristic points CP that is finally determined for the target face image OI is shown. By disposing the characteristic points CP, the positions of the characteristic portions (person's face organs (the eyebrows, the eyes, the nose, and the mouth) and predetermined positions in the contour of a face) of the target face image OI are specified. Accordingly, the shapes and the positions of the person's face organs and the contour and the shape of the face of the target face image OI can be specified.

In the above-described face characteristic specifying process (FIG. 9), the initial disposition of the characteristic points CP is determined based on the result of comparing the target face image OI with each image of the average face image group. Thereafter, the disposition of the characteristic points CP in the target face image OI is updated based on the result of comparing the average shape image I(W(x;p)) calculated from the target face image OI with the average face image A₀(x). In particular, in the initial disposition determining process for the characteristic points CP, the approximate values of global parameters that define the overall size, the tilt, the positions (the positions located on the upper and lower sides and the positions located on the left and right sides) of the disposition of the characteristic points CP are determined. Thereafter, the disposition of the characteristic points CP is updated in accordance with the update of the parameters performed based on the differential image Ie, and the final disposition of the characteristic points CP in the target face image OI is determined. As described above, by first determining the approximate values of the global parameters that have great variance (large dispersion) in the overall disposition of the characteristic points CP in the initial disposition determining process, the efficiency, the speed, and the accuracy of the face characteristic position specifying process can be improved (final determination on the disposition of the characteristic points CP not on the basis of so-called a local optimized solution but on the basis of a global optimized solution).

### Comparative Example

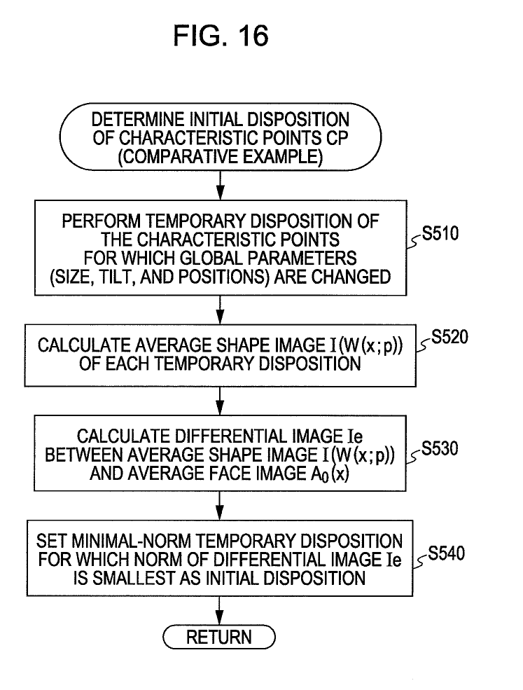

FIG. 16 is a flowchart showing steps of an alternate initial disposition determining process for the characteristic points CP. The alternate initial disposition determining process provides a comparative example that illustrates advantages of the above-described initial disposition determining process. In Step S510, the initial disposition portion 211 (FIG. 1) sets temporary disposition of the characteristic points CP on the target face image OI by variously changing the values of the size, the tilt, the positions (the positions located on the upper and lower sides and the positions located on the left and right sides) as the global parameters.

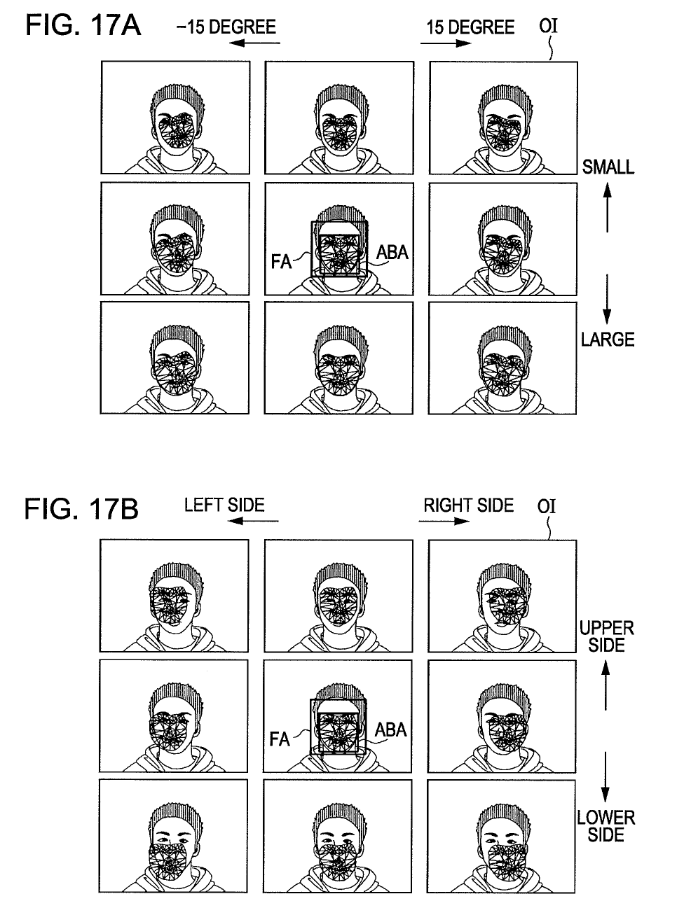

FIGS. 17A and 17B are explanatory diagrams showing exemplary temporary dispositions of the characteristic points CP in the target face image OI. In FIGS. 17A and 17B, the temporary dispositions of the characteristic points CP in the target face image OI is represented by meshes. The initial disposition portion 211, as shown in FIGS. 17A and 17B on the center, sets the temporary disposition (hereinafter, also referred to as “reference temporary disposition”) specified by the characteristic points CP of the average face image A₀(x) for a case where the average face image A₀(x) (FIG. 8) is overlapped with the assumed reference area ABA (see FIG. 10) of the target face image OI.

The initial disposition portion 211 sets temporary disposition by variously changing the values of the global parameters for the reference temporary disposition. The changing of the global parameters (the size, the tilt, the positions in the vertical direction, and the positions in the horizontal direction) corresponds to performing enlargement or reduction, a change in the tilt, and parallel movement of the meshes that specify the temporary disposition of the characteristic points CP. Accordingly, the initial disposition portion 211, as shown in FIG. 17A, sets temporary disposition (shown below or above the reference temporary disposition) specified by meshes acquired by enlarging or reducing the meshes of the reference temporary disposition at a predetermined scaling factor and temporary disposition (shown on the right side or the left side of the reference temporary disposition) that is specified by meshes acquired by changing the tilt of the meshes of the reference temporary disposition by a predetermined angle in the clockwise direction or the counterclockwise direction. In addition, the initial disposition portion 211 also sets temporary disposition (shown on the upper left side, the lower left side, the upper right side, and the lower right side of the reference temporary disposition) specified by meshes acquired by performing a transformation combining enlargement or reduction and a change in the tilt of the meshes of the reference temporary disposition.

In addition, as shown in FIG. 12B, the initial disposition portion 211 sets temporary disposition (shown above or below the reference temporary disposition) that is specified by meshes acquired by performing parallel movement of the meshes of the reference temporary disposition by a predetermined amount to the upper side or the lower side and temporary disposition (shown on the left side and the right side of the reference temporary disposition) that is specified by meshes acquired by performing parallel movement of the reference temporary disposition to the left or right side. In addition, the initial disposition portion 211 sets temporary disposition (shown on the upper left side, the lower left side, the upper right side, and the lower right side of the reference temporary disposition) that is specified by meshes acquired by performing the transformation combining the parallel movement to the upper or lower side and the left or right side for the meshes of the reference temporary disposition.

In addition, the initial disposition portion 211 also sets temporary disposition that is specified by meshes, shown in FIG. 17B, acquired by performing parallel movement to the upper or lower side and to the left or right side for the meshes of eight temporary dispositions other than the reference temporary disposition shown in FIG. 17A. Accordingly, in the comparative example, a total of 81 types of the temporary dispositions including the reference temporary disposition and 80 types of temporary dispositions that are set by performing 80 (=3×3×3×3−1) types of transformations corresponding to combinations of three-level values of four global parameters (the size, the tilt, the positions in the vertical direction, and the positions in the horizontal direction) for meshes of the reference temporary disposition are set.

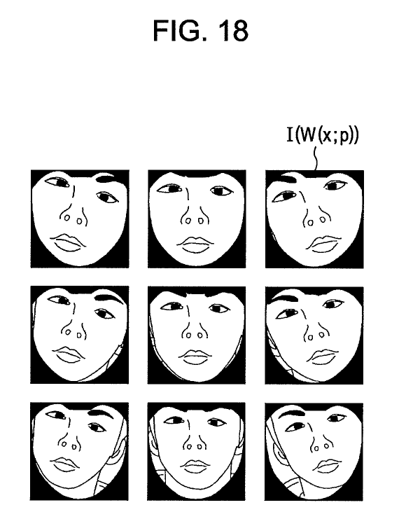

In Step S520 (FIG. 16), the image transforming portion 212 (FIG. 1) calculates the average shape image I(W(x;p)) corresponding to each temporary disposition that has been set. FIG. 18 is an explanatory diagram showing an example of the average shape images I(W(x;p)). The method of calculating the average shape image I(W(x;p)) is the same as the method of calculating the average shape image I(W(x;p)) (Step S410) used in the characteristic point CP disposition updating process (FIG. 14) according to the above-described process. In other words, the average shape image I(W(x;p)) is acquired by specifying the average shape area BSA (an area surrounded by characteristic points CP that are located on the outer periphery) by performing temporal disposition of the characteristic points CP in the target face image OI and performing an affine transformation for each triangle area TA of the average shape area BSA of the target face image OI. The average shape image I(W(x;p)), similarly to the average face image A₀(x), is configured by an average shape area BSA and a mask area MA and is calculated as an image having the same size as that of the average face image A₀(x). In FIG. 18, nine average shape images I(W(x;p)) corresponding to nine temporary dispositions shown in FIG. 17A are shown.

In Step S530 (FIG. 16), the initial disposition portion 211 (FIG. 1) calculates a differential image Ie between the average shape image I(W(x;p)) corresponding to each temporary disposition and the average face image A₀(x). Since 81 types of the temporary dispositions of the characteristic points CP are set, the initial disposition portion 211 calculates 81 differential images Ie.

In Step S540 (FIG. 16), the initial disposition portion 211 (FIG. 1) calculates norms of the differential images Ie and sets temporary disposition (hereinafter, also referred to as “minimal norm temporary disposition”) corresponding to the differential image Ie having the smallest value of the norm as the initial disposition of the characteristic points CP in the target face image OI.

As described above, even by performing the initial disposition determining process (FIG. 16) for the characteristic points CP according to the comparative example, the initial disposition in the target face image OI can be determined. However, in the initial disposition determining process of the characteristic points CP according to the comparative example, the average shape images I(W(x;p)) are calculated by performing relatively complicated calculation of the affine transformation for each triangle area TA in all the 81 temporary dispositions. Accordingly, the processing time increases. On the other hand, in the above-described initial disposition determining process (FIG. 11) of the characteristic points CP, only calculation (performing calculation 81 times) of differences between the target face image OI and 81 face images included in the average face image group is performed. Accordingly, the relatively complicated calculation of the affine transformation for each triangle area TA is reduced significantly.

### Alternate Initial Disposition Determination Process

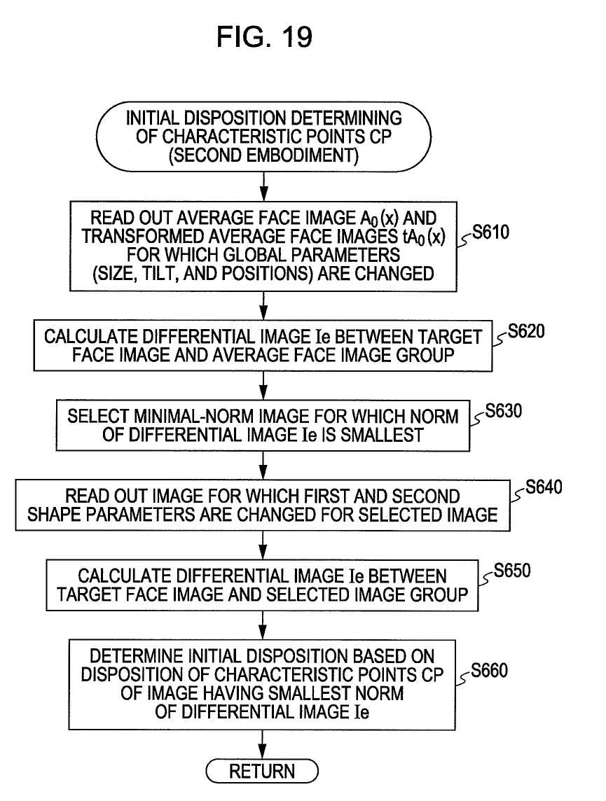

FIG. 19 is a flowchart showing steps of an initial disposition determining process for the characteristic points CP, in accordance with many embodiments. As described above, the transformed average face images tA₀(x) that are generated by performing a transformation such as a transformation of changing the global parameters for the average face image A₀(x) can be set in advance and stored in the internal memory 120 as the AAM information AMI. Additionally, images acquired by performing transformation of changing a shape parameter pᵢ of the first shape vector sᵢ and a shape parameter p₂ of the second shape vector s₂ for the average face image group (the average face image A₀(x) and the transformed average face images tA₀(x)) in the above-described shape model can be additionally set in advance and stored as the AAM information AMI. In many embodiments, for each image of the average face image group, eight types (=3×3−1) of images are set in accordance with eight types of changes corresponding to combinations of three-level values (0, +V, and −V) of the shape parameters p₁ and p₂. The eight types of transformation are referred to herein as M (wherein M is a positive integer) types of transformation.

As described above, the first shape vector s₁ and the second shape vector s₂ are shape vectors sᵢ corresponding to two principal components (the first principal component and the second principal component) having the greatest variance for a shape model. The first shape vector s₁ is a vector that is approximately correlated with the horizontal appearance of a face, and the second shape vector s₂ is a vector that is approximately correlated with the vertical appearance of a face. Accordingly, in many embodiments, for each image of the average face image group, images in which the degree of the horizontal appearance of the face and the vertical appearance of the face are changed are set in advance.

The processing contents of Steps S610 and S620 of the initial disposition determining process (FIG. 19) for the characteristic points CP are the same as those of Steps S310 and S320 shown in FIG. 11. In Step S630, the initial disposition portion 211 (FIG. 1) calculates the norms of the differential images Ie, and selects an image (hereinafter, also referred to as a “selected image”) corresponding to the differential image Ie having the smallest value of the norm from the average face image group.

In Step S640 (FIG. 19), the initial disposition portion 211 (FIG. 1) reads out eight types of images acquired by changing at least one of the shape parameters p₁ and p₂ for the selected image. The eight types of images are referred to herein as transformed selected images. Hereinafter, the selected image and the read-out eight types of images are collectively referred to as a selected image group.

In Step S650 (FIG. 19), the initial disposition portion 211 (FIG. 1) calculates differential images Ie between the assumed reference area ABA (FIG. 10) of the target face image OI and the eight types of images included in the selected image group.

In Step S660 (FIG. 19), the initial disposition portion 211 (FIG. 1) calculates the norms of the differential images Ie, selects an image corresponding to the differential image Ie having the smallest value of the norm from the selected image group, and determines the initial disposition of the characteristic points CP in the target face image OI based on the disposition of the characteristic points CP of the selected image.

As described above, approximate values of the first shape parameter p₁ of the first shape vector s₁ and the shape parameter p₂ of the second shape vector s₂ corresponding to the two principal components having the greatest variance are set for the global parameters that define the overall size, the tilt, and the positions (positions located on the upper and lower sides and the positions located on the left side or the right side) of the disposition of characteristic points CP for the target face image OI and the shape model. In many embodiments, only calculation of differences between the target face image OI and the 81 types of the face images included in the average face image group and calculation of differences between the target face image OI and the eight types of the images included in the selected image group are performed. Accordingly, relatively complicated calculations of the affine transformation for each triangle area TA are significantly reduced.

### Exemplary Variations

The present invention is not limited to the above-described embodiments or examples. Thus, various embodiments can be enacted without departing from the scope of the basic idea of the present invention. For example, the modifications describe below can be made.

In the above-described embodiments, a total of 80 types of the transformed average face images tA₀(x) acquired by performing a total of 80 types (=3×3×3×3−1) of transformation corresponding to combinations of three-level values for each of four global parameters (the size, the tilt, the positions in the vertical direction, and the positions in the horizontal direction) are set in advance for the average face image A₀(x). However, the types and the number of the parameters used for setting the transformed average face images tA₀(x) or the number of levels of the parameter values can be changed. For example, only some of the four global parameters may be configured to be used for setting the transformed average face images tA₀(x). Alternatively, at least some of the global parameters and a predetermined number of the shape parameters pᵢ may be configured to be used for setting the transformed average face images tA₀(x). Furthermore, the transformed average face images tA₀(x) may be configured to be set by performing a transformation corresponding to combinations of five-level values for each parameter used.

In the above-described alternate initial disposition process, for each average face image group (the average face image A₀(x) and the transformed average face images tA₀(x)), images corresponding to combinations of three-level values of the shape parameters p₁ and p₂ corresponding to two principal components having the greatest variance for the shape model are set in advance. However, the number of the shape parameters pᵢ or the number of the level of the parameter values can be changed. For example, only the shape parameter pᵢ corresponding to one principal component having the greatest variance may be used. Alternatively, the shape parameters pᵢ corresponding to three principal components or more selected from the greatest variance side may be configured to be used. In addition, for example, the number of levels of the parameter values may be set to five.

In the updating process (FIG. 14) for the disposition of the characteristic position CP in each of the above-described embodiments, by calculating the average shape image I(W(x;p)) based on the target face image OI, the disposition of the characteristic points CP of the target face image OI is matched to the disposition of the characteristic points CP of the average face image A₀(x). However, both the dispositions of the characteristic points CP may be configured to be matched to each other by performing an image transformation for the average face image A₀(x).

In the above-described embodiments, the face area FA is detected, and the assumed reference area ABA is set based on the face area FA. However, the detection of the face area FA does not necessarily need to be performed. For example, the assumed reference area ABA may be set by user's direct designation.

In the above-described embodiments, the sample face image SI (FIG. 3) is only an example, and the number and the types of images used as the sample face images SI can be varied. In addition, the predetermined characteristic portions (see FIG. 4) of a face that are represented in the positions of the characteristic points CP in each of the above-described embodiments are only an example. Thus, some of the characteristic portions set in the above-described embodiments can be omitted, or other portions may be used as the characteristic portions.

In addition, in the above-described embodiments, the texture model is set by performing principal component analysis for the luminance value vector that is configured by luminance values for each pixel group x of the sample face image SIw. However, the texture mode may be set by performing principal component analysis for index values (for example, RGB values) other than the luminance values that represent the texture of the face image.

In addition, in the above-described embodiments, the size of the average face image A₀(x) is not limited to 56 pixels×56 pixels and can be configured to be different. In addition, the average face image A₀(x) does not need to include the mask area MA (FIG. 7) and may be configured by just the average shape area BSA. Furthermore, instead of the average face image A₀(x), a different reference face image that is set based on statistical analysis for the sample face images SI can be used.

In addition, in the above-described embodiments, the shape model and the texture model that use the AAM are set. However, the shape model and the texture model may be set by using any other modeling technique (for example, a technique called a Morphable Model or a technique called an Active Blob).

In addition, in the above-described embodiments, the image stored in the memory card MC is configured as the target face image OI. However, for example, the target face image OI can be an image that is acquired through a network.

In addition, in the above-described embodiments, the image processing performed by using the printer 100 as an image processing apparatus has been described. However, a part of or the whole processing can be configured to be performed by an image processing apparatus of any other type such as a personal computer, a digital camera, or a digital video camera. In addition, the printer 100 is not limited to an ink jet printer and may be a printer of any other type such as a laser printer or a sublimation printer.

In the above-described embodiments, a part of the configuration that is implemented by hardware can be replaced by software. Likewise, a part of the configuration implemented by software can be replaced by hardware.

In addition, in a case where a part of or the entire function according to an embodiment of the invention is implemented by software, the software (computer program) can be provided in a form being stored on a computer-readable recording medium. The “computer-readable recording medium” in an embodiment of the invention is not limited to a portable recording medium such as a flexible disk or a CD-ROM and includes various types of internal memory devices of a computer such a RAM and a ROM and an external memory device such as a hard disk that is fixed to a computer.

Other variations are within the spirit of the present invention. Thus, while the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

What is claimed is:

1. An image processing apparatus that specifies a position of a predetermined characteristic portion of a target face image, the image processing apparatus comprising:
a processor; and
a machine readable memory coupled with the processor and comprising instructions that when executed cause the processor to
generate an initial disposition of characteristic points in the target face image in response to comparing each image of a plurality of images in a reference face image group with the target face image, the reference face image group generated by applying a first plurality of transformations to a reference face image having a known disposition of characteristic points,
apply a second transformation to at least one of the reference face image and the reference face image characteristic points or the target face image and the target face image initial characteristic points such that
the transformed target face image initial characteristic points match the reference face image characteristic points, or
the transformed reference face image characteristic points match the target face image initial characteristic points; and
update the target face image initial characteristic points in response to a comparison between at least one of
the reference face image and the target face image as transformed by the second transformation, or
the target face image and the reference face image as transformed by the second transformation.

2. The image processing apparatus according to claim 1, wherein the update of the target face image initial characteristic points is contingent on the results of at least one of
a comparison between the reference face image and the target face image as transformed by the second transformation, or
a comparison between the target face image and the reference face image as transformed by the second transformation.

3. The image processing apparatus according to claim 1, wherein the first plurality of transformations comprises at least one of a parallel movement, a change in tilt, an enlargement, or a reduction of the reference face image characteristic points in the reference face image.

4. The image processing apparatus according to claim 1, wherein the reference face image is generated from a plurality of sample face images, each sample face image having a known disposition of characteristic points.

5. The image processing apparatus according to claim 4, further comprising a memory unit that stores a characteristic point disposition model comprising a sum of average positions of the characteristic points in the plurality of sample face images and a linear combination of shape vectors representing characteristics of the disposition of the characteristic points in the plurality of sample face images, and wherein
one image in the reference face image group is selected in response to a comparison between each image of the reference face image group with the target face image,
a selected image group is generated in response to the selected image of the reference face image group, the selected image group generated by applying a third plurality of transformations to the selected image of the reference face image group, the third plurality of transformations comprising at least one coefficient of a predetermined number of the shape vectors having the greatest variance in the disposition model, and
the disposition of the target face image initial characteristic points is generated in response to comparing each image of the selected image group with the target face image.

6. The image processing apparatus according to claim 4, wherein the reference face image is generated by averaging the characteristic points of the sample face images.

7. The image processing apparatus according to claim 1, wherein the target face image initial characteristic points are set to match the characteristic points of an image of the reference face image group that most closely corresponds to a predetermined area of the target face image.

8. The image processing apparatus according to claim 6, further comprising a face-area detecting unit that detects a face area corresponding to a face image in the target face image,
wherein the predetermined area is an area for which relationship with the face area is set in advance.

9. A method of specifying a position of a predetermined characteristic portion of a target face image, the method using a computer comprising:
determining an initial disposition of characteristic points in the target face image in response to comparing each image of a plurality of images in a reference face image group with the target face image, the reference face image group generated by applying a first plurality of transformations to a reference face image having a known disposition of characteristic points;
applying a second transformation to at least one of the reference face image and reference face image characteristic points or the target face image and the target face image initial characteristic points such that
the transformed target face image initial characteristic points match the reference face image characteristic points, or
the transformed reference face image characteristic points match the target face image initial characteristic points; and
updating the target face image initial characteristic points in response to a comparison between at least one of
the reference face image and the target face image as transformed by the second transformation, or
the target face image and the reference face image as transformed by the second transformation.

10. A computer program for image processing to specify a position of a predetermined characteristic portion of a target face image, the computer program implementing functions comprising:
a function for determining an initial disposition of characteristic points in the target face image in response to comparing each image of a plurality of images in a reference face image group with the target face image, the reference face image group generated by applying a first plurality of transformations to a reference face image having a known disposition of characteristic points;
a function for applying a second transformation to at least one of the reference face image and reference face image characteristic points or the target face image and the target face image initial characteristic points such that
the transformed target face image initial characteristic points match the reference face image characteristic points, or
the transformed reference face image characteristic points match the target face image initial characteristic points; and
a function for updating the target face image initial characteristic points in response to a comparison between at least one of
the reference face image and the target face image as transformed by the second transformation, or
the target face image and the reference face image as transformed by the second transformation.
